(19) United States
(12) Patent Application Publication
(10) Pub. No.: US 2025/0202328 A1
(43) Pub. Date: Jun. 19, 2025

(54) VIBRATION MOTOR AND TOUCH DEVICE

(71) Applicant: AAC Microtech (Changzhou) Co., Ltd., Changzhou (CN)

(72) Inventors: Lubin Mao, Changzhou (CN); Xingzhi Huang, Changzhou (CN); Wei Song, Changzhou (CN); Jie Ma, Changzhou (CN); Yun Tang, Changzhou (CN)

(21) Appl. No.: 18/633,567

(22) Filed: Apr. 12, 2024

Related U.S. Application Data
(63) Continuation of application No. PCT/CN2023/139715, filed on Dec. 19, 2023.

(51) Int. Cl. H02K 33/02; H02K 11/00; H02K 33/18

(52) U.S. Cl. CPC H02K 33/02; H02K 11/0094; H02K 33/18

(57) ABSTRACT

A vibration motor includes a housing having an accommodating space, a stator, and a vibrator fixed to the housing. The stator includes two magnetic elements spaced opposite to each other along a first direction, and the vibrator includes a spring sheet and a solenoid. The spring sheet is fixed to the housing, and the solenoid is fixedly connected to the spring sheet to be suspended between the two magnetic elements. The two magnetic elements drive the solenoid to vibrate in a third direction, and the housing has an opening. The first direction, the second direction and the third direction are perpendicular to each other. The present application further provides a touch control device including the vibration motor. Therefore, the variation in the driving force of the vibrator at different positions is relatively small, thereby avoiding experience discrepancies caused by assembly tolerances to ensure the consistency of the whole machine.

### CROSS-REFERENCE TO RELATED APPLICATIONS

This application is a continuation of International Application No. PCT/CN2023/139715, filed on Dec. 19, 2023, the entire contents of which are incorporated herein by reference.

### TECHNICAL FIELD

The present application relates to the field of vibration feedback technologies, in particular to a vibration motor and a touch device.

### BACKGROUND

Vibration feedback technology can reproduce tactile sensations for users through a series of actions such as exerting force and vibration. This mechanical stimulus is applied to touch devices.

The vibration feedback technology in the related art is achieved by applying static pressure (typically generated by pressing with fingers) to cause displacement of the vibrator motor's reed in the direction of the applied static pressure. When the sensor detects this static pressure information, the vibrator motor operates to generate tactile feedback, thereby creating an analog vibration sensation. Specifically, the reed of the vibrator motor undergoes deformation and reversal when subjected to external forces (such as finger pressure), allowing users to perceive the pressing feedback. However, in the related art, during the assembly of the entire device, it is necessary to fix an outer shell of the motor to a middle frame of the touch device, as well as to fix a vibrator of the motor to a button set on the middle frame. This assembly method results in uncontrolled and relatively random positions of the vibrator, leading to significant variations in the driving force of the vibrator at different positions due to changes in assembly tolerances, thereby resulting in differences in tactile feedback experiences.

Therefore, it is necessary to study a vibration motor with a new structure.

### SUMMARY

The present application solves the problem of significant variations in the driving force of the vibrator at different positions caused by assembly tolerances during the assembly of the vibrator motor as a whole, and provides a vibrator motor with a new structure.

In order to realize the above object, the present application provides a vibration motor comprising:
a housing with an accommodating space;
a stator fixed in the housing, comprising two magnetic elements arranged opposite to each other and spaced apart along a first direction; and
a vibrator fixed in the housing, comprising a spring sheet and a solenoid, the spring sheet being fixed to the housing at both ends in a second direction, the solenoid being fixedly connected to the spring sheet to be suspended between the two magnetic elements;
wherein two magnetic elements drive the solenoid to vibrate along a third direction, at least one side of the housing in the third direction is provided an opening in communication with the accommodating space; the first direction, the second direction, and the third direction are perpendicular to each other.

As an improvement, the magnetic elements are magnets, and the magnetic elements are magnetized along the first direction.

As an improvement, each of the magnetic elements is magnetized in three segments to form a first magnetic segment, a second magnetic segment, and a third magnetic segment distributed sequentially along the third direction, wherein the first magnetic segments of the two magnetic elements are arranged opposite to each other with the same polarity, the second magnetic segments of the two magnetic elements are arranged opposite to each other with the same polarity, and the third magnetic segments of the two magnetic elements are arranged opposite to each other with the same polarity;
in the same magnetic element, a magnetization direction of the first magnetic segment is opposite to a magnetization direction of the second magnetic segment; and
in the same magnetic element, the magnetization direction of the first magnetic segment is the same as a magnetization direction of the third magnetic segment.

As an improvement, the magnetic elements are unipolar magnets, and two magnetic elements co-polarized opposite to each other.

As an improvement, each of the magnetic elements comprises a first magnet, a second magnet, and a third magnet distributed sequentially along the third direction; the first magnet, the second magnet, and the third magnet are magnetized along the first direction, wherein the first magnets of the two magnetic elements are arranged opposite to each other with the same polarity, the second magnets of the two magnetic elements are arranged opposite to each other with the same polarity, and the third magnets of the two magnetic elements are arranged opposite to each other with the same polarity;
in the same the magnetic element, a magnetization direction of the first magnet is opposite to a magnetization direction of the second magnet; and
in the same the magnetic element, the magnetization direction of the first magnet is the same as a magnetization direction of the third magnet.

As an improvement, the solenoid comprises a coil and a core body; the core body comprises a main body portion wound by the coil, and an extension portion formed by extending from the main body portion and is fixedly connected to the spring sheet.

As an improvement, a orthographic projection of the coil on the magnetic element falls within a range of the magnetic elements.

As an improvement, a side of the extension portion away from the main body portion extends along the third direction to form at least two spaced apart positioning posts, and the spring sheet is provided with through holes for insertion of the positioning posts.

As an improvement, the housing comprises a first wall, a second wall, a third wall and a fourth wall connected in turn to form the accommodating space; two ends of the spring sheet are fixed to the first wall and the third wall, respectively; and the magnetic elements are fixed to an inner side of the second wall and an inner side of the fourth wall.

As an improvement, the spring sheet is located in the opening, and a buffer sheet is fixedly arranged on a side of the spring sheet away from the housing.

In order to achieve the above object, the present application provides a touch control device comprising a center frame having a mounting hole, a button mounted in the mounting hole, and any one of the above-mentioned vibration motors; wherein the housing of the vibration motor is fixed to an inner side of the center frame, the vibrator of the vibration motor is connected to the button through the opening, and a pressing direction of the button is parallel to the vibration motor in the third direction.

The beneficial effect of the present application is that: the stator includes two magnetic elements arranged opposite to each other in a first direction and spaced apart, and the vibrator includes a spring sheet and a solenoid. Both ends of the spring sheet along the second direction are fixed to the housing, and the solenoid is fixedly connected to the spring sheet to be suspended between the two magnetic elements. the two magnetic elements are configured to drive the solenoid to vibrate along the third direction, and at least one side of the housing along the third direction is provided with an opening in communication with the accommodating space. The first direction, the second direction, and the third direction are perpendicular to each other. In this way, after the vibration motor is assembled in the whole machine, the driving force of the vibrator in different positions varies relatively little, thus avoiding differences in experience due to variations in assembly tolerances and ensuring the consistency of the whole machine.

### BRIEF DESCRIPTION OF THE DRAWINGS

FIG. 1 is a three-dimensional view of the touch control device according to Embodiment One of the present application.

FIG. 2 is an exploded view of the touch control device shown in FIG. 1.

FIG. 3 is a three-dimensional view of a vibration motor in the touch control device shown in FIG. 2.

FIG. 4 is an exploded view of the vibration motor shown in FIG. 3.

FIG. 5 is a partially enlarged view of the touch control device shown in FIG. 1 in a sectional view along the A-A direction.

FIG. 6 is a partially enlarged view of the touch control device shown in FIG. 1 in a sectional view along the B-B direction.

FIG. 7 is a partially enlarged view of the touch control device in a sectional view along the B-B direction according to Embodiment Two of the present application.

FIG. 8 is a structural schematic diagram of magnetic elements in the touch control device according to Embodiment Three of the present application.

### DETAILED DESCRIPTION OF THE EMBODIMENTS

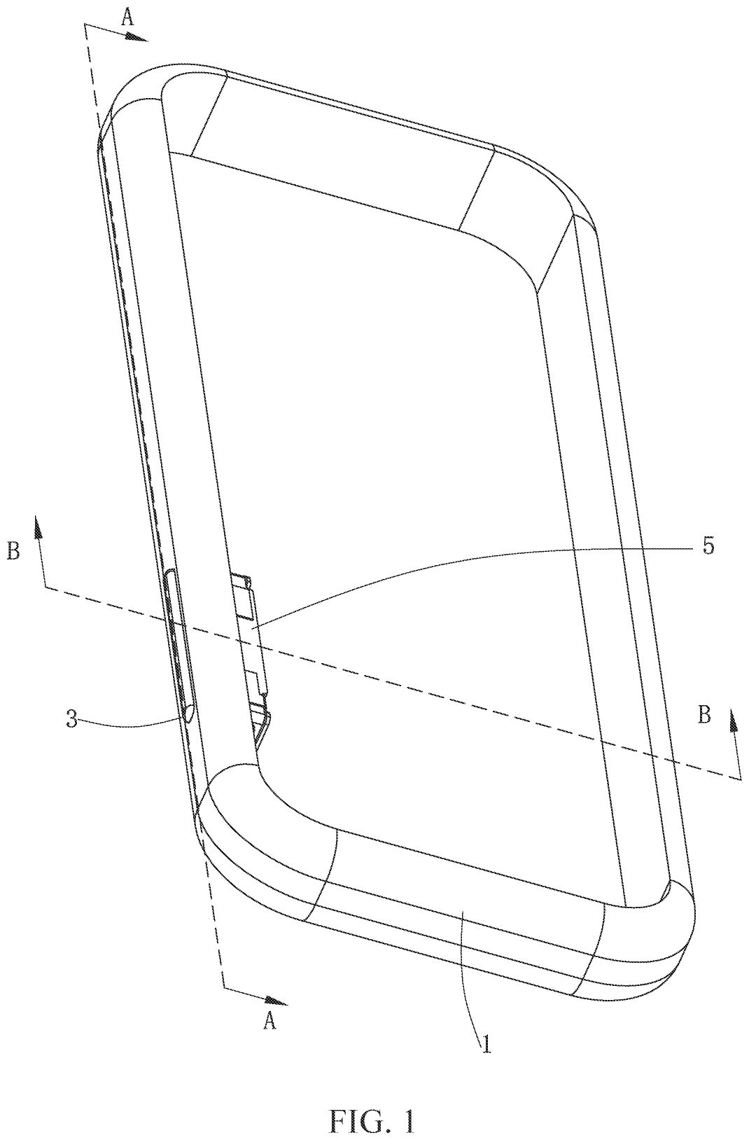

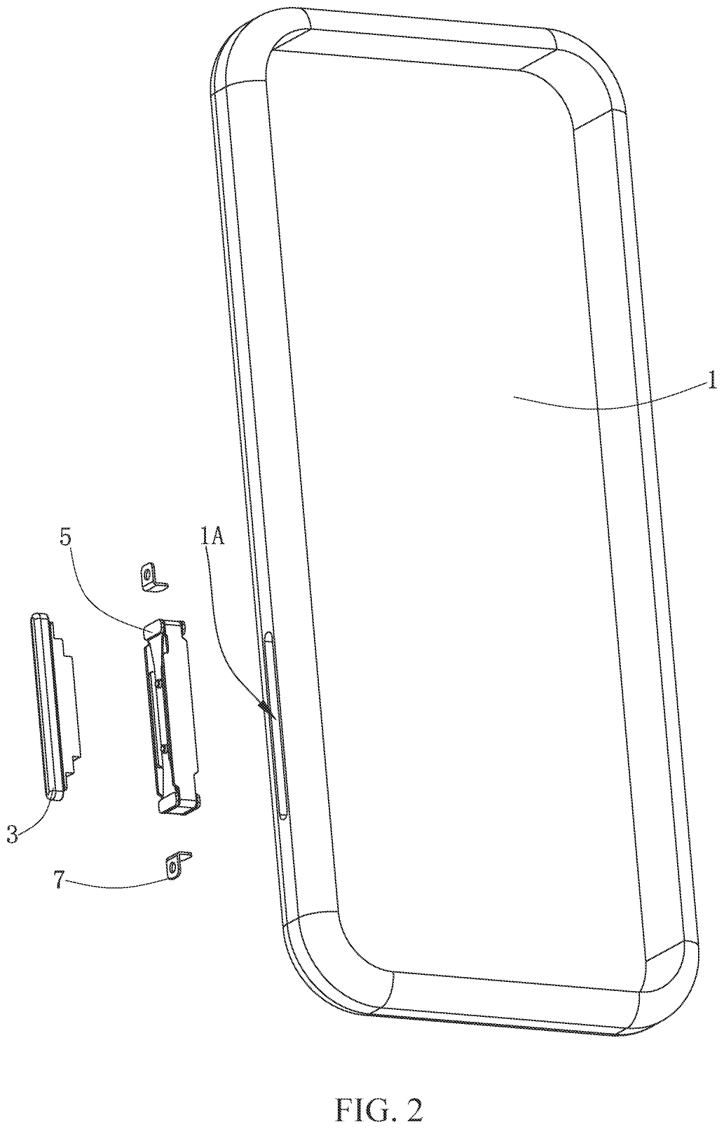

The present application is described in detail below in conjunction with FIGS. 1 to 7.

The touch control devices of the present application include, but are not limited to, devices that require button operation scenarios such as smartphones, Augmented Reality (AR) glasses, car steering wheels, smart grips, watches, and the like. The following ARE only examples of smartphones for a detailed description.

### Embodiment One

As shown in FIGS. 1 to 6, the touch control device of the present application includes a center frame 1 having a mounting hole 1A, a button 3 mounted in the mounting hole 1A, and a vibration motor 5 fixed to an inner side of the center frame 1. The button 3 protrudes from an outer side of the center frame 1 so as to facilitate the finger applying a pressing force to the button 3, and a direction of the pressing force of the button 3 is parallel to a vibration direction of the vibration motor 5.

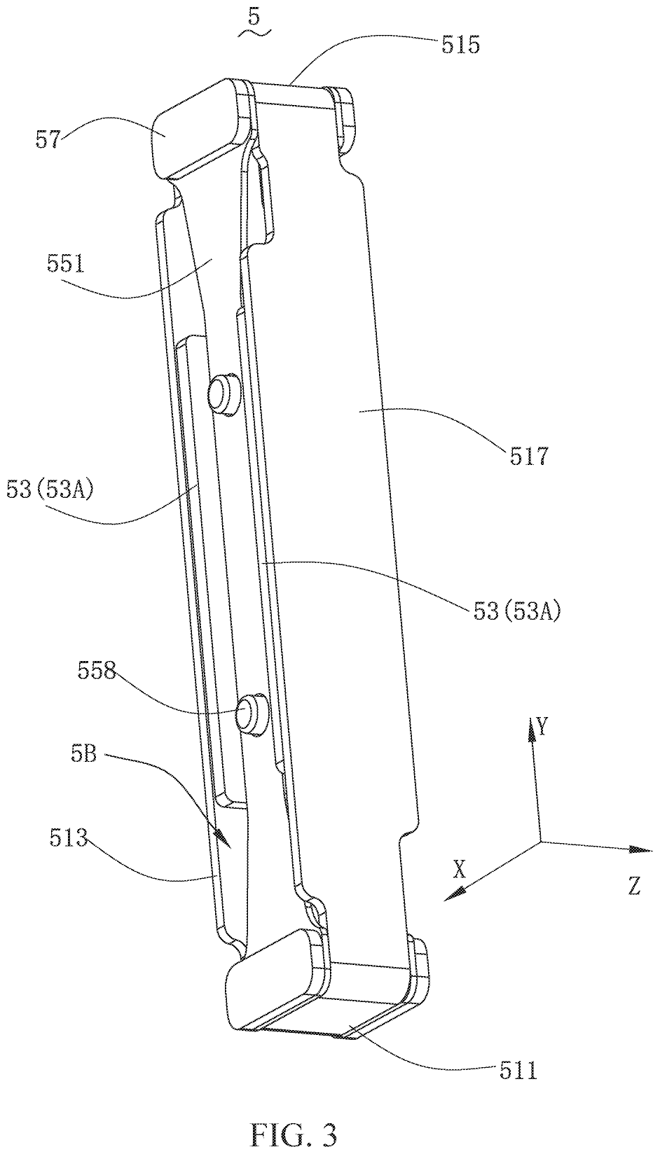

As shown in FIGS. 3 to 6, it is defined that a width direction of the vibration motor 5 is a first direction X, a length direction thereof is a second direction Y, and a height direction thereof is a third direction Z. The first direction X, the second direction Y, and the third direction Z are perpendicular to each other. The vibration direction of the vibration motor 5 is the third direction Z.

The vibration motor 5 includes a housing 51 having an accommodating space 5A, a stator 53 fixed in the housing 51, and a vibrator 55 fixed in the housing 51.

The housing 51 is fixed to an inner side of the center frame 1. At least one side of the housing 51 along the third direction Z is provided with an opening 5B in communication with the accommodating space 5A, to enable the vibrator 55 to be connected to the button 3 through the opening 5B. The stator 53 drives the vibrator 55 to vibrate along the third direction Z, and drive the button 3 to vibrate to produce a tactile sensation, thereby producing a simulated vibratory sensation experience.

In this embodiment, both sides of the housing 51 along the third direction Z are provided with openings 5B in communication with the accommodating space 5A.

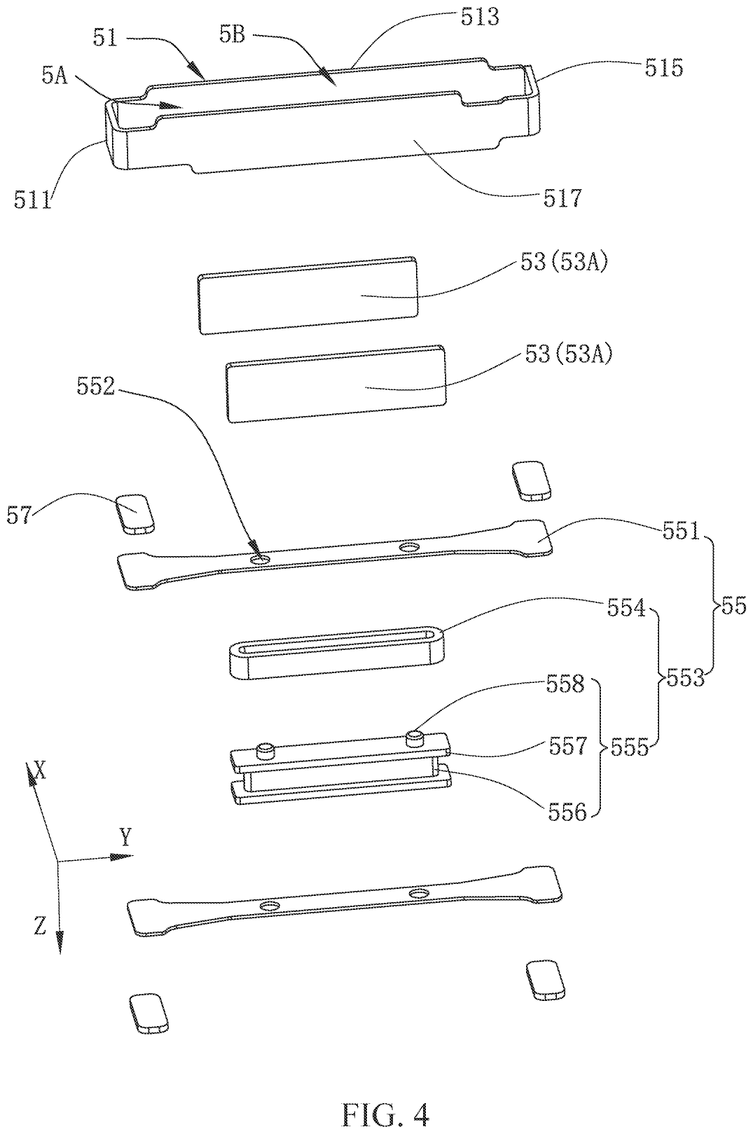

As shown in FIGS. 3 and 4, the housing 51 includes a first wall 511, a second wall 513, a third wall 515, and a fourth wall 517 that are sequentially connected at the head and tail to enclose and form the accommodating space 5A. The first wall 511 and the third wall 515 are arranged opposite to each other and spaced apart along the second direction Y. The second wall 513 and the fourth wall 517 are arranged opposite to each other and spaced apart along the first direction X. Both ends of the housing 51 along the third direction Z are defined to form the openings 5B, respectively.

In this embodiment, the housing 51 is fixed to the inner side of the center frame 1 through connecting members 7.

Each connecting member 7 includes a first connecting portion 71, and a second connecting portion 73 connected to the first connecting portion 71. The first connecting portion 71 is connected to the housing 51, and the second connecting portion 73 is connected to the center frame 1.

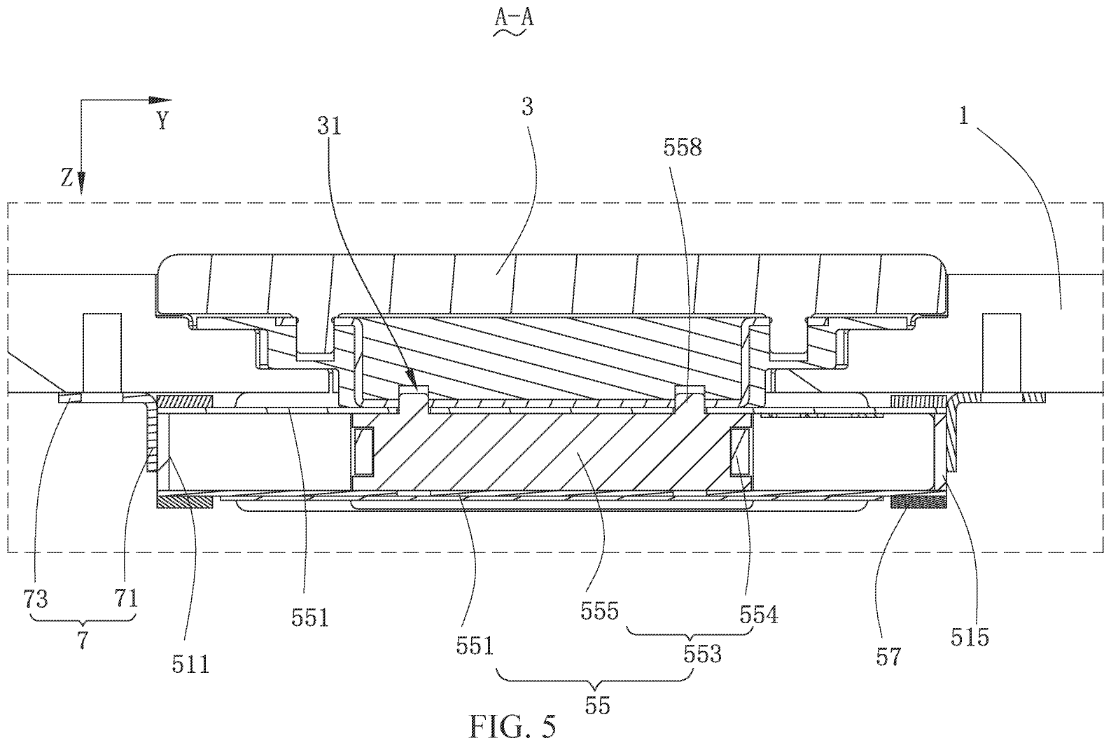

As shown in FIG. 5, the first connecting portion 71 of one connecting member 7 is welded to the first wall 511, and the first connecting portion 71 of the other connecting member 7 is welded to the third wall 515. The second connecting portion 73 is formed by bending from the first connecting portion 71, and the second connecting portion 73 is connected to the center frame 1 by fasteners.

The stator 53 includes two magnetic elements 53A arranged opposite and spaced apart along the first direction X.

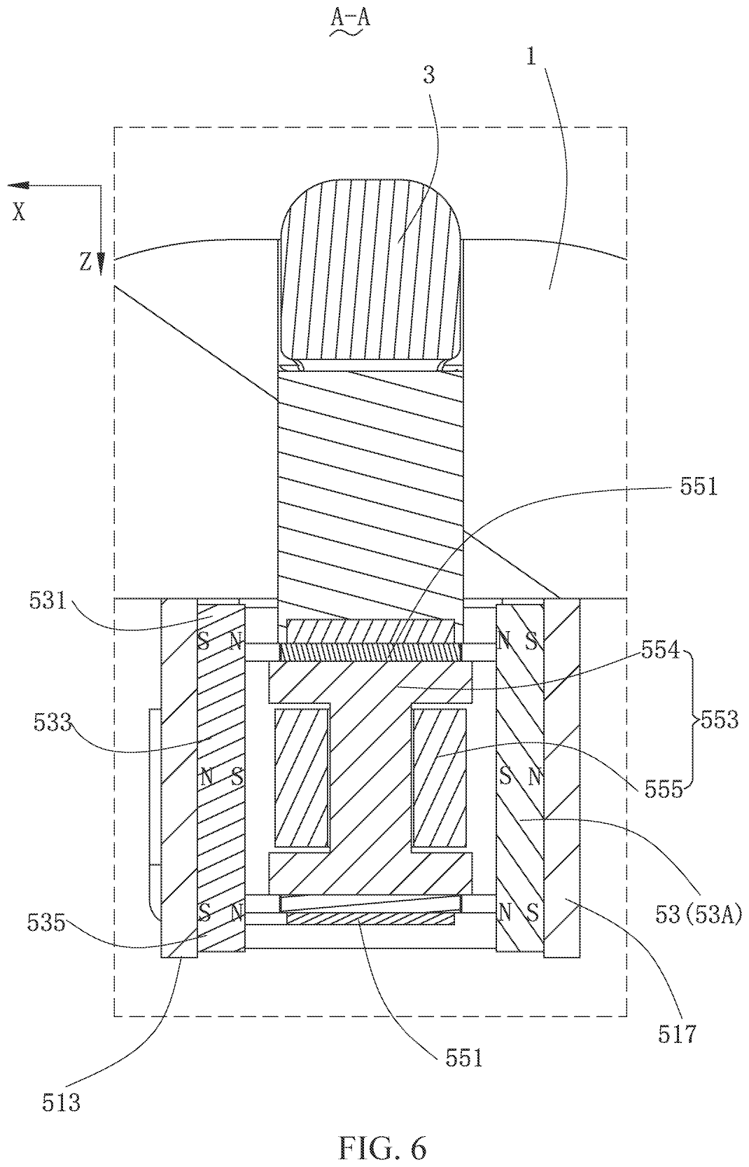

As shown in FIG. 6, an inner side of the second wall 513 and an inner side of the fourth wall 517 are both provided with the magnetic elements 53A. i.e., the stator 53 is fixedly provided within the housing 51.

In this embodiment, the magnetic elements 53A are magnets, and the magnetic elements 53A are magnetized along the first direction X.

It should be noted that the first direction X includes a forward direction and a reverse direction. As shown in FIG. 6, the magnetic elements 53A are magnetized along the first direction X, i.e., the magnetic element 53A is magnetized along its thickness direction.

In this embodiment, each magnetic element 53A is magnetized in three segments to form a first magnetic segment 531, a second magnetic segment 533, and a third magnetic segment 535 that are sequentially distributed along the third direction Z.

It should be noted that the three-segment magnetization means: each magnetic element 53A forms three magnetic poles on a surface perpendicular to the first direction X, i.e., the first magnetic segment 531, the second magnetic segment 533, and the third magnetic segment 535 all include N poles and S poles distributed along the first direction X.

The first magnetic segments 531 of the two magnetic elements 53A are arranged opposite to each other with the same polarity, the second magnetic segments 533 of the two magnetic elements 53A are arranged opposite to each other with the same polarity, and the third magnetic segments 535 of the two magnetic elements 53A are arranged opposite to each other with the same polarity. In the same magnetic element 53A, a magnetization direction of the first magnetic segment 531 is opposite to a magnetization direction of the second magnetic segment 533, and the magnetization direction of the first magnetic segment 531 is the same as a magnetization direction of the third magnetic segment 535.

It should be noted that the magnetization direction of the first magnetic segment 531 is opposite to the magnetization direction of the second magnetic segment 533 means: one of the magnetization direction of the first magnetic segment 531 and the magnetization direction of the second magnetic segment 533 is a positive direction of the first direction X, and the other is a negative direction of the first direction X. As shown in FIG. 6, along the third direction Z, the magnetic poles on a side of the magnetic element 53A close to the solenoid 553 are distributed as N-S-N, and accordingly, the magnetic poles on a side of the magnetic element 53A away from the solenoid 553 are distributed as S-N-S. It will be appreciated that in other embodiments, along the third direction Z, the magnetic poles on the side of the magnetic element 53A close to the solenoid 553 may also be distributed as S-N-S, and accordingly, the magnetic poles on the side of the magnetic element 53A away from the solenoid 553 are distributed according to N-S-N.

The vibrator 55 includes a spring sheet 551 connected to the button 3 and a solenoid 553. An axis of the solenoid 553 is parallel to the third direction Z.

Both ends of the spring sheet 551 along the second direction Y are fixed to the housing 51. Specifically, both ends of the spring sheet 551 along the second direction Y are fixed to the first wall 511 and the third wall 515, respectively.

The solenoid 553 is fixedly connected to the spring sheet 551 to be suspended between the two magnetic elements 53A, and the two magnetic elements 53A drive the solenoid 553 to vibrate along the third direction Z.

As shown in FIGS. 4-6, two opposite sides of the solenoid 553 along the third direction Z are connected to a spring sheet 551.

The solenoid 553 includes a coil 554 and a core body 555. As shown in FIG. 6, a orthographic projection of the coil 554 on the magnetic elements 53A falls within a range of the magnetic element 53A.

During normal operation, the button 3 is pressed with a finger to generate pressure along the second direction, which is perpendicular to the surface of button 3. The pressure causes deformation of the spring sheet 551. The sensor detects the action information of this pressure through the deformation of the spring sheet 551, and the action information includes the position information and the magnitude information of the pressure. Through processing by the processor and signal algorithm, corresponding electrical signals are sent to the vibration motor 5. When the vibration motor 5 is energized, the coil 554 is supplied with alternating current to generate a changing magnetic field along the third direction Z. This alternating magnetic field interacts with the magnetic field formed by the two magnetic elements 53A, causing the solenoid 553 to undergo linear reciprocating motion along the third direction Z. The spring sheet 551 provides elastic restoring force during the linear reciprocating motion (i.e., the vibrator 55 of the vibration motor 5 vibrates along the third direction Z), thereby providing tactile feedback to the user.

The core body 555 includes a main body portion 556 wound by the coil 554 and an extension portion 557 formed by extending from the main body portion 556 and fixedly connected to the spring sheet 551.

In this embodiment, the core body 555 is made of a readily magnetizable material to allow the magnetism generated by the energization of the coil 554 to magnetize the core body 555 and enhance the strength of the magnetic field of the solenoid 553, so that the magnitude of the current passing through the core body 555 can be reduced if the same driving force is required. Typically, the core body 555 is made of an iron core, i.e. the solenoid 553 is an electromagnet.

In this embodiment, a side of the extension portion 557 away from the main body portion 556 extends along the third direction Z to form at least two spaced-apart positioning posts 558. The spring sheet 551 is provided with through-holes 552 for the insertion of the positioning posts 558. The through-holes 552 are provided to facilitate the positioning of the spring sheet 551 and the solenoid when assembling the vibration motor 5.

As shown in FIG. 5, the button 3 is further provided with positioning holes 31 for insertion of the positioning posts 558. The positioning holes 31 are provided to facilitate positioning of the button 3 and the spring sheet 551 when assembling the vibration motor 5.

In this embodiment, the spring sheet 551 is located at the opening 5B, and a side of the spring sheet 551 away from the housing 51 is fixedly provided with a buffer sheet 57. The provision of the buffer sheet 57 prevents the spring sheet 551 from colliding with the center frame or/and the other devices of the touch control device when vibrating, thereby improving reliability.

### Embodiment Two

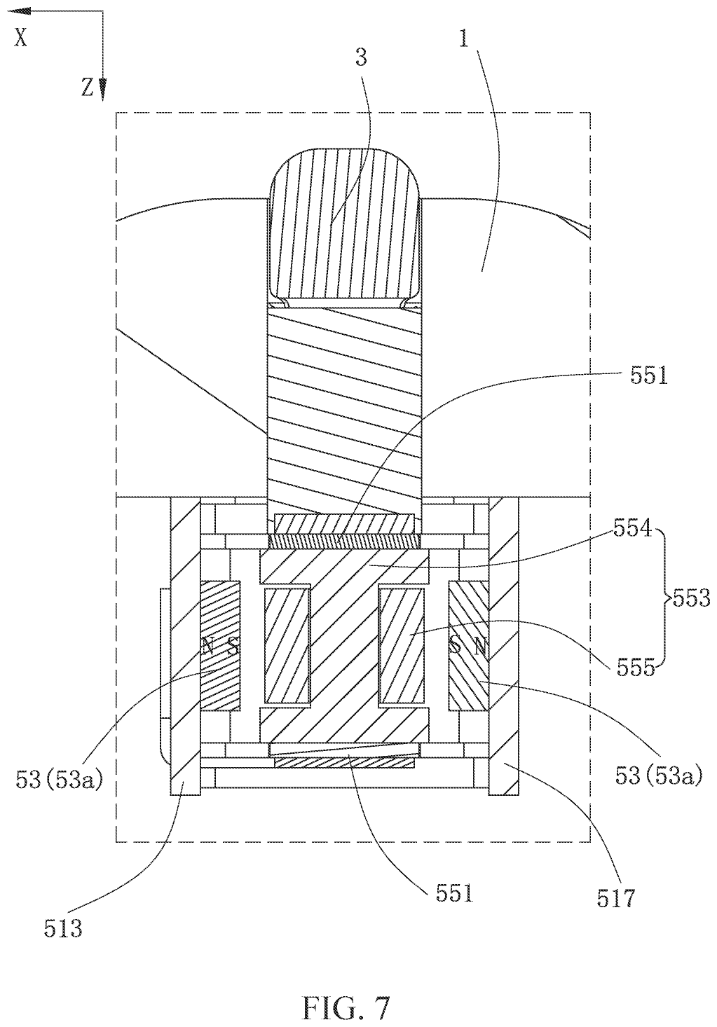

Referring to FIG. 7, Embodiment Two differs from Embodiment One only in that: each magnetic element 53a is a unipolar magnet, and the two magnetic elements 53a are arranged opposite to each other with the same polarity.

It should be noted that in other embodiments, the magnetic elements 53a in Embodiment Two may also be replaced with a solenoid structure. However, compared to the magnet, the magnetic element 53a of the solenoid structure not only has a smaller driving force, but also has a more complex magnetic circuit structure and driving method.

### Embodiment Three

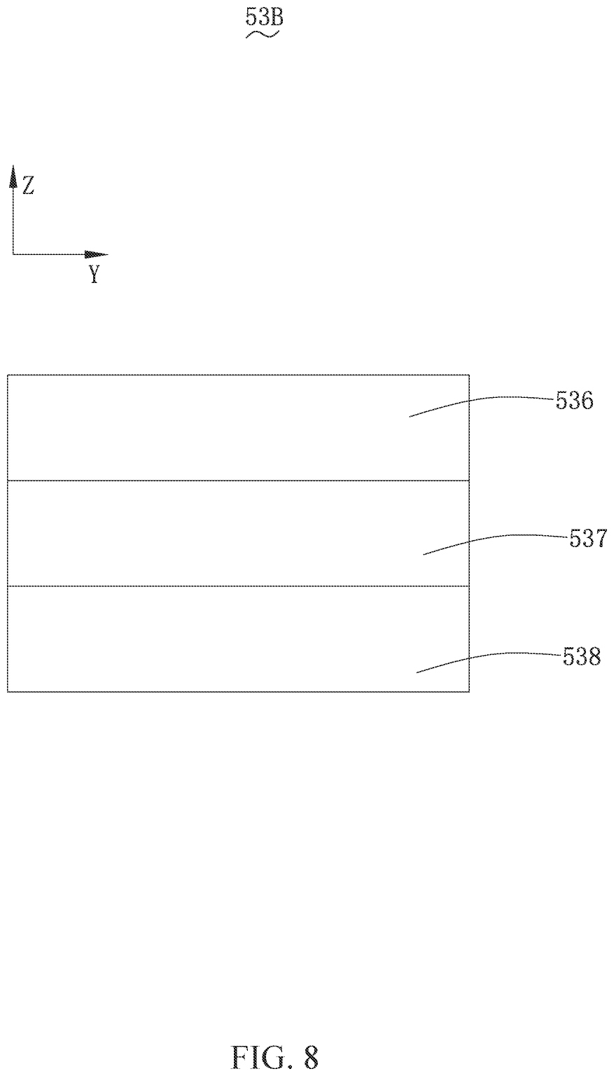

Referring to FIG. 8, Embodiment Three differs from Embodiment One only in that:

each magnetic element 53B includes a first magnet 536, a second magnet 537, and a third magnet 538 sequentially distributed along a third direction Z. The first magnet 536, the second magnet 537, and the third magnet 538 are magnetized along the first direction X.

The first magnet 536 of the two magnetic elements 53B are arranged opposite to each other with the same polarity, the second magnet 537 of the two magnetic elements 53B are arranged opposite to each other with the same polarity, and the third magnet 538 of the two magnetic elements 53B are arranged opposite to each other with the same polarity.

In the same magnetic element 53B, a magnetization direction of the first magnet 536 is opposite to a magnetization direction of the second magnet 537.

In the same magnetic element 53B, the magnetization direction of the first magnet 536 is the same as a magnetization direction of the third magnet 538.

It should be noted that in other embodiments, the first magnet 536, the second magnet 537, and the third magnet 538 may also be replaced with solenoid structures.

It should also be noted that in other embodiments, the stator may further include two magnetic elements spaced apart along the second direction and magnetized along the second direction, and the four magnetic elements are assembled into a frame stator. In this circumstance, the two magnetic elements spaced apart along the second direction are required to avoid the spring sheet in order to reserve the vibration space for the spring plates. Thus, the size of the two magnetic elements spaced apart along the second direction in the vibratory direction is not too large and should be smaller than the size of the two magnetic elements spaced apart along the first direction X in the vibration direction.

Described above are only embodiments of the present application. It should be noted herein that improvements may be made for those of ordinary skill in the art without departing from the inventive conception of the present application, but these fall within the protection scope of the present application.

What is claimed is:

1. A vibration motor, comprising:
a housing with an accommodating space;
a stator fixed in the housing, comprising two magnetic elements arranged opposite to each other and spaced apart along a first direction; and
a vibrator fixed in the housing, comprising a spring sheet and a solenoid, the spring sheet being fixed to the housing at both ends in a second direction, the solenoid being fixedly connected to the spring sheet to be suspended between the two magnetic elements;
wherein the two magnetic elements are configured to drive the solenoid to vibrate along a third direction, and at least one side of the housing in the third direction is provided an opening in communication with the accommodating space; the first direction, the second direction, and the third direction are perpendicular to each other.

2. The vibration motor of claim 1, wherein the magnetic elements are magnets, and the magnetic elements are magnetized along the first direction.

3. The vibration motor of claim 2, wherein each of the magnetic elements is magnetized in three segments to form a first magnetic segment, a second magnetic segment, and a third magnetic segment distributed sequentially along the third direction, wherein the first magnetic segments of the two magnetic elements are arranged opposite to each other with the same polarity, the second magnetic segments of the two magnetic elements are arranged opposite to each other with the same polarity, and the third magnetic segments of the two magnetic elements are arranged opposite to each other with the same polarity;
in the same magnetic element, a magnetization direction of the first magnetic segment is opposite to a magnetization direction of the second magnetic segment; and
in the same magnetic element, the magnetization direction of the first magnetic segment is the same as a magnetization direction of the third magnetic segment.

4. The vibration motor of claim 2, wherein each of the magnetic elements is a unipolar magnet, and the two magnetic elements are arranged opposite to each other with the same polarity.

5. The vibration motor of claim 1, wherein each of the magnetic elements comprises a first magnet, a second magnet, and a third magnet distributed sequentially along the third direction; the first magnet, the second magnet, and the third magnet are magnetized along the first direction, wherein
the first magnets of the two magnetic elements are arranged opposite to each other with the same polarity, the second magnets of the two magnetic elements are arranged opposite to each other with the same polarity, and the third magnets of the two magnetic elements are arranged opposite to each other with the same polarity;
in the same the magnetic element, a magnetization direction of the first magnet is opposite to a magnetization direction of the second magnet; and
in the same the magnetic element, the magnetization direction of the first magnet is the same as a magnetization direction of the third magnet.

6. The vibration motor of claim 1, wherein the solenoid comprises a coil and a core body; the core body comprises a main body portion wound by the coil, and an extension portion formed by extending from the main body portion and is fixedly connected to the spring sheet.

7. The vibration motor of claim 6, wherein a orthographic projection of the coil on the magnetic element falls within a range of the magnetic elements.

8. The vibration motor of claim 6, wherein a side of the extension portion away from the main body portion extends along the third direction to form at least two spaced apart positioning posts, and the spring sheet is provided with through holes for insertion of the positioning posts.

9. The vibration motor of claim 1, wherein the housing comprises a first wall, a second wall, a third wall, and a fourth wall connected in turn to form the accommodating space; two ends of the spring sheet are fixed to the first wall and the third wall, respectively; and the magnetic elements are fixed to an inner side of the second wall and an inner side of the fourth wall.

10. The vibration motor of claim 1, wherein the spring sheet is located in the opening, and a buffer sheet is fixedly arranged on a side of the spring sheet away from the housing.

11. A touch control device, comprising:
a center frame having a mounting hole;
a button mounted in the mounting hole; and
a vibration motor of claim 1;
wherein the housing of the vibration motor is fixed to an inner side of the center frame, the vibrator of the vibration motor is connected to the button through the opening, and a pressing direction of the button is parallel to the third direction of the vibration motor.

12. The touch control device of claim 11, wherein the magnetic elements are magnets, and the magnetic elements are magnetized along the first direction.

13. The touch control device of claim 12, wherein each of the magnetic elements is magnetized in three segments to form a first magnetic segment, a second magnetic segment and a third magnetic segment distributed sequentially along the third direction, wherein the first magnetic segments of the two magnetic elements are arranged opposite to each other with the same polarity, the second magnetic segments of the two magnetic elements are arranged opposite to each other with the same polarity, and the third magnetic segments of the two magnetic elements are arranged opposite to each other with the same polarity;
in the same magnetic element, a magnetization direction of the first magnetic segment is opposite to a magnetization direction of the second magnetic segment; and
in the same magnetic element, the magnetization direction of the first magnetic segment is the same as a magnetization direction of the third magnetic segment.

14. The touch control device of claim 12, wherein each of the magnetic elements is a unipolar magnet, and the two magnetic elements are arranged opposite to each other with the same polarity.

15. The touch control device of claim 11, wherein each of the magnetic elements comprises a first magnet, a second magnet and a third magnet distributed sequentially along the third direction; the first magnet, the second magnet, and the third magnet are magnetized along the first direction, wherein
the first magnets of the two magnetic elements are arranged opposite to each other with the same polarity, the second magnets of the two magnetic elements are arranged opposite to each other with the same polarity, and the third magnets of the two magnetic elements are arranged opposite to each other with the same polarity;
in the same the magnetic element, a magnetization direction of the first magnet is opposite to a magnetization direction of the second magnet; and
in the same the magnetic element, the magnetization direction of the first magnet is the same as a magnetization direction of the third magnet.

16. The touch control device of claim 11, wherein the solenoid comprises a coil and a core body; the core body comprises a main body portion wound by the coil, and an extension portion formed by extending from the main body portion and is fixedly connected to the spring sheet.

17. The touch control device of claim 16, wherein a orthographic projection of the coil on the magnetic element falls within a range of the magnetic elements.

18. The touch control device of claim 16, wherein a side of the extension portion away from the main body portion extends along the third direction to form at least two spaced apart positioning posts, and the spring sheet is provided with through holes for insertion of the positioning posts.

19. The touch control device of claim 11, wherein the housing comprises a first wall, a second wall, a third wall and a fourth wall connected in turn to form the accommodating space; two ends of the spring sheet are fixed to the first wall and the third wall, respectively; and the magnetic elements are fixed to an inner side of the second wall and an inner side of the fourth wall.

20. The touch control device of claim 11, wherein the spring sheet is located in the opening, and a buffer sheet is fixedly arranged on a side of the spring sheet away from the housing.
